(19) United States
(12) Patent Application Publication
(10) Pub. No.: US 2011/0066946 A1
(43) Pub. Date: Mar. 17, 2011

(54) Transmitting and editing method for multimedia audio-visual device

(76) Inventor: Chen-Yao Chen, Chung Ho City (TW)

(21) Appl. No.: 12/585,528

(22) Filed: Sep. 17, 2009

(51) Int. Cl. G06F 3/00

(52) U.S. Cl. 715/723

(57) ABSTRACT

In a transmitting and editing method for multimedia audio-visual device, the following steps are included: providing a multimedia audio-visual device internally provided with a control circuit, which includes a microprocessor, a system control unit, a multimedia processing unit, a standard system I/O unit, an audio/video interface unit, a memory unit, and a network transmission unit, and supports an audio/video editing and online transmitting application program executable on a computer; connecting the multimedia audio-visual device to a computer for the system control unit to automatically enable the audio/video editing and online transmitting application program; using the audio/video editing and online transmitting application program to grab desired audio/video files stored in the memory unit for playing or editing; and transmitting the edited audio/video files via the network transmission unit according to a user's selection to share the audio/video files with other users over networks or emails.

### FIELD OF THE INVENTION

The present invention relates to a transmitting and editing method for multimedia audio-visual device, and more particularly to a method for a multimedia audio-visual device to provide combined functions of taking pictures, inputting music, playing and editing stored audio/video data, and transmitting audio/video files over a network for sharing the files with other users.

### BACKGROUND OF THE INVENTION

Generally, a digital camera and an MP4 player are two independent and separate devices. A user has to use different application programs to perform different data playing, editing, and network transmission functions on the two devices, which is of course very inconvenient to the user. It is therefore tried by the inventor to develop a transmitting and editing method for multimedia audio-visual device, so that a user can conveniently perform audio/video data playing, editing, online transmission, and data sharing over network all on the same one multimedia audio-visual device.

### SUMMARY OF THE INVENTION

A primary object of the present invention is to provide a transmitting and editing method for multimedia audio-visual device, so that when a multimedia audio-visual device is connected to a computer having an audio/video editing and online transmitting application program installed thereon, the audio/video editing and online transmitting application program is automatically enabled to grab audio/video files stored on the multimedia audio-visual device for playing and editing, or for online transmission to share the audio/video files with other users over networks or emails.

To implement the transmitting and editing method of the present invention, the multimedia audio-visual device includes a main body, which is internally provided with a control circuit for processing, storing and playing audio/video data, and the control circuit includes a microprocessor or central processing unit (CPU), a network transmission unit, an audio/video interface unit, and a multimedia processing unit. By operating the multimedia audio-visual device, different functions, such as taking or shooting pictures, recording music, listening to radio, etc., all can be performed with the multimedia audio-visual device.

The audio/video editing and online transmitting application program allows a user to play and edit the audio/video files stored on the multimedia audio-visual device, and to directly transmit the desired audio/video files over a network for sharing the audio/video files with other users over the network or emails, allowing the multimedia audio-visual device to provide combined and useful functions of editing and online transmitting audio/video media.

With the present invention, when the multimedia audio-visual device is connected to a computer having the audio/video editing and online transmitting application program installed thereon, the audio/video data editing and online transmitting application program is automatically enabled to grab audio/video files stored on the multimedia audio-visual device for playing and editing, or for directly transmitting over a network to share the audio/video files with other users over the network or emails. Therefore, the multimedia audio-visual device has increased value for use.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a front perspective view of a multimedia audio-visual device for which a transmitting and editing method according to the present invention is implemented;

FIG. 2 is a rear perspective view of the multimedia audio-visual device of FIG. 1; and

FIG. 3 is a block diagram showing a preferred embodiment of a control circuit for the multimedia audio-visual device.

### DETAILED DESCRIPTION OF THE PREFERRED EMBODIMENTS

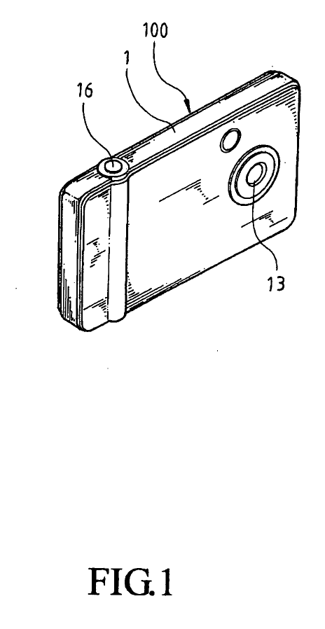

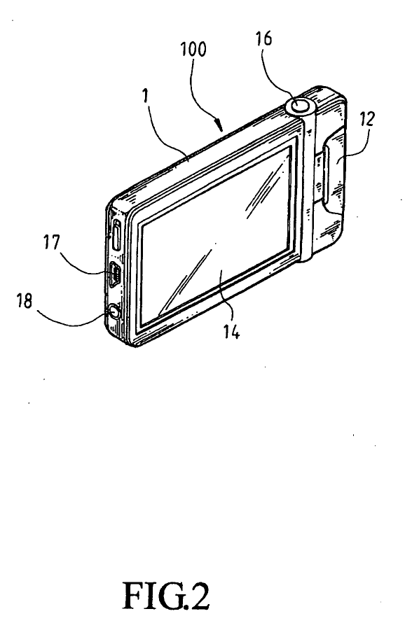

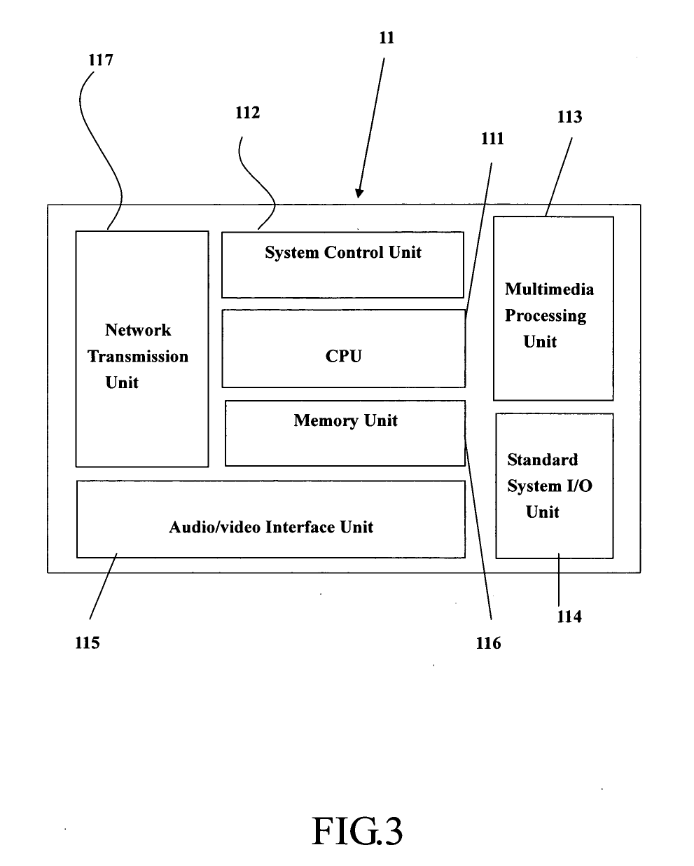

Please refer to FIGS. 1 and 2 that are front and rear perspective views, respectively, of a multimedia audio-visual device 100, for which a transmitting and editing method according to the present invention is implemented; and to FIG. 3 that is a block diagram showing a preferred embodiment of a control circuit 11 for the multimedia audio-visual device 100. As shown, the multimedia audio-visual device 100 includes a main body 1, a plurality of operation keys 12 and input/output (I/O) connectors, a micro camera lens 13, and a liquid crystal display (LCD) 14. The operation keys 12 are arranged at one lateral side of a rear face of the main body 1. A cylindrical expanded portion 15 is provided on the main body 1 adjacent to the operation keys 12, facilitating easy holding of the multimedia audio-visual device 100 at the expanded portion 15 by a user, and a shutter release button 16 is provided on a top of the cylindrical expanded portion 15. A universal serial bus (USB) socket 17 and an earphone jack 18 are provided on the main body 1 at predetermined positions. To implement the method of the present invention, the control circuit 11 for the multimedia audio-visual device 100 includes a microprocessor or central processing unit (CPU) 111 for executing a predetermined program to process audio/video data; a system control unit 112 for driving the CPU 111 to work; a multimedia processing unit 113 for processing audio/video and image data; a standard system I/O unit 114 for receiving and outputting data; an audio/video interface unit 115 connected to the LCD 14 and the micro camera lens 13 and connectable to an external earphone for receiving audio/video data, transferring the received audio/video data to the CPU 111, and transferring data from the CPU 111 for outputting; a memory unit 116 for storing data therein; and a network transmission unit 117 for transmitting audio/video data over a network.

The multimedia audio-visual device 100 with the above structure can be operated to play music, listen to radio, or record sound, or be switched to a camera mode and then operate the micro camera lens 13 and the shutter release button 16 to shoot or take pictures. Images of pictures taken can be stored in the memory unit 116, and the stored images can be played back on the LCD 14.

The multimedia audio-visual device 100 supports audio/video editing and online transmission. When the multimedia audio-visual device 100 is connected to a computer having an audio/video editing and online transmission application program installed thereon, the system control unit 112 of the multimedia audio-visual device 100 automatically enables the audio/video editing and online transmission application program, so that the latter automatically grabs audio/video files stored in the memory unit 116 of the multimedia audio-visual device 100 for playing and/or editing these files, or directly transmitting these files via the network transmission unit 117 for sharing them with other network users on a website, such as YouTube, or in emails. For example, a user of the multimedia audio-visual device 100 can use the network transmission unit 117 and the audio/video editing and online transmission application program to edit and upload a file stored on the multimedia audio-visual device 100 to the website of YouTube to share the file with other users. Similarly, the user of the multimedia audio-visual device 100 can also download audio/video files that are uploaded to YouTube by other users. Therefore, the multimedia audio-visual device 100 can provide the user with combined functions of editing and online transmitting multimedia audio-visual data.

As can be seen from FIG. 2, the multimedia audio-visual device 100 is provided with a USB socket 17 and an earphone jack 18. A USB flash disk (not shown) can be externally connected to the USB socket 17, so that data on the flash disk can be input to and stored in the memory unit 116, giving the multimedia audio-visual device 100 increased value of application. An earphone (not shown) can be externally connected to the earphone jack 18, so that a user can listen to music files stored in the memory unit 116, radio programs, or music videos.

In brief, the present invention provides a transmitting and editing method for a multimedia audio-visual device, so that the multimedia audio-visual device can integrate audio/video data and automatically enable an audio/video editing and online transmitting application program run on a computer, allowing a user to conveniently enjoy the functions of taking pictures, recording music, editing audio/video files, transmitting audio/video files over network to share the files with other users.

Through the method of the present invention, an audio/video editing and online transmitting application program run on a computer cooperates with the control circuit of a multimedia audio-visual device to allow grabbing, editing, and playing audio/video files stored on the multimedia audio-visual device, and transmitting the audio/video files over a network. Therefore, the multimedia audio-visual device is more valuable and practical for use.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A transmitting and editing method for multimedia audio-visual device, comprising the following steps:
providing a multimedia audio-visual device, which is internally provided with a control circuit for processing, storing, and playing audio/video data, and externally provided with a micro camera lens, an LCD, a plurality of operation keys, and a plurality of connection sockets;
providing the control circuit with a microprocessor or CPU for processing audio/video data using a predetermined audio/video editing and online transmitting application program; a system control unit for driving the CPU to work; a multimedia processing unit for processing audio/video and image data; a standard system I/O unit for receiving and outputting data; an audio/video interface unit connected to the LCD and the micro camera lens and connectable to an external earphone for receiving audio/video data, transferring the received audio/video data to the CPU, and transferring data from the CPU for outputting; a memory unit for storing data therein; and a network transmission unit for transmitting audio/video data over a network;
connecting the multimedia audio-visual device to a computer having the editing and online transmitting application program installed thereon, so that the system control unit automatically enables the editing and online transmitting application program;
using the editing and online transmitting application program to grab desired audio/video files stored in the memory unit of the multimedia audio-visual device for playing or editing; and
transmitting the edited audio/video files via the network transmission unit according to a user's selection to share the audio/video files with other users over a network.
